(19) United States
(12) Patent Application Publication
(10) Pub. No.: US 2026/0296242 A1
(43) Pub. Date: Oct. 1, 2026

(54) CONTROL DEVICE AND CONTROL METHOD

(71) Applicant: HONDA MOTOR CO., LTD., Tokyo (JP)

(72) Inventors: Seiya Nagase, Tokyo (JP); Takuya Tanaka, Tokyo (JP); Shin Shigeoka, Tokyo (JP)

(21) Appl. No.: 19/455,917

(22) Filed: Jan. 22, 2026

(30) Foreign Application Priority Data
Mar. 28, 2025 (JP) 2025-056563

(51) Int. Cl. B60L 53/60; B60L 55/00

(52) U.S. Cl. CPC B60L 53/60; B60L 55/00

(57) ABSTRACT

A control device controls an amount of power demand of power supplied from an external power source to a battery of a vehicle in response to a request for demand response (DR). The control device includes a calculation unit configured to calculate a baseline indicating a predicted value of an amount of power demand expected in a case where DR is not implemented, on the basis of performance data indicating a past amount of power demand, calculate a target total power at the time of securing, which indicates a maximum amount of power to be secured based on the baseline, on the basis of contracted power determined in accordance with a DR bidding result, and calculate a planned total power, which indicates a predicted value of an amount of power demand expected in a case where DR is not implemented, on the basis of a charging plan for the vehicle.

### CROSS-REFERENCE TO RELATED APPLICATION

Priority is claimed on Japanese Patent Application No. 2025-056563, filed Mar. 28, 2025, the content of which is incorporated herein by reference.

### BACKGROUND OF THE INVENTION

### Field of the Invention

The present invention relates to a control device and a control method.

### Description of Related Art

In recent years, demand response (hereinafter referred to as “DR”), which adjusts demand on a consumer side, has become known as a method for balancing supply and demand of power. In response to a request for DR (hereinafter referred to as a “DR request”), consumers can contribute to improving the balance between supply and demand of power by reducing or increasing their power consumption (demand) compared to normal times, and receive incentives commensurate with their contributions. In such DR, control is performed based on a baseline that indicates the amount of power demand that is expected in a case where there was no DR request.

Patent Document 1 listed below proposes a method for shortening the time required to calculate a baseline by calculating a provisional baseline on the basis of performance data indicating the amount of power demand prior to the target day of DR, determining a correction value using current day data indicating the amount of power demand on the target day, and recalculating the baseline using the correction value.
[Patent Document 1] Japanese Unexamined Patent Application, First Publication No. 2020-202637

### SUMMARY OF THE INVENTION

Meanwhile, research is underway into a mechanism for controlling DR by using vehicle-to-grid (V2G) technology, which supplies power from batteries installed in vehicles to the power grid, and controlling the charging and discharging of batteries installed in vehicles. In DR using a battery installed in such a vehicle, in a case where control is performed based on the baseline in the above-mentioned related art, there is a concern that the resources necessary for power adjustment cannot be appropriately secured. For example, in a case where a large error occurs between the actual demand due to the charging response of the actual vehicle incorporated into the DR control and the pre-expected demand, there is a concern that resources cannot be secured.

The aspects of the present invention have been made in consideration of the above circumstances, and one object thereof is to provide a control device and a control method that can improve the accuracy of resource securing in DR.

To solve the above-described problems, the present invention employs the following configuration.
(1): According to an aspect of the present invention, there is provided a control device that controls an amount of power demand of power supplied from an external power source to a battery of a vehicle in response to a request for demand response (DR). The control device includes: a calculation unit configured to calculate a baseline indicating a predicted value of an amount of power demand expected in a case where DR is not implemented, on the basis of performance data indicating a past amount of power demand, calculate a target total power at the time of securing, which indicates a maximum amount of power to be secured based on the baseline, on the basis of contracted power determined in accordance with a DR bidding result, and calculate a planned total power, which indicates a predicted value of an amount of power demand expected in a case where DR is not implemented, on the basis of a charging plan for the vehicle; and a resource securing unit configured to secure a first resource, which is an amount of power from the planned total power to the baseline, and a second resource, which is an amount of power from the planned total power to the target total power at the time of securing.
(2): In the above aspect (1), the resource securing unit may be configured to, under a condition that the request for DR is a request to reduce the amount of power demand, secure the second resource in a case where the planned total power is greater than the baseline, and secure the first resource and the second resource in a case where the planned total power is less than the baseline, and under a condition that the request for DR is a request to increase the amount of power demand, secure the second resource in a case where the planned total power is less than the baseline, and secure the first resource and the second resource in a case where the planned total power is greater than the baseline.
(3): In the above aspect (1) or (2), the control device may further include a margin securing unit configured to secure at least one of a first margin, which is an extra margin of an amount of power in a first direction of the baseline from the planned total power, and a second margin, which is an extra margin of an amount of power in a second direction of the target total power at the time of securing from the planned total power.
(4): In the above aspect (3), the margin securing unit may secure at least the second margin.
(5): In the above aspect (3), the margin securing unit may be configured to, under a condition that the request for DR is a request to reduce the amount of power demand, calculate and secure the second margin in a case where the planned total power is greater than the baseline, and calculate and secure the first margin and the second margin in a case where the planned total power is less than the baseline, and under a condition that the request for DR is a request to increase the amount of power demand, calculate and secure the second margin in a case where the planned total power is less than the baseline, and calculate and secure the first margin and the second margin in a case where the planned total power is greater than the baseline.
(6): In the above aspect (1) or (2), the calculation unit may calculate an amount of power up to a target total power determined in accordance with the planned total power and a DR request value, and the control device may further include an allocation instruction unit configured to instruct an allocation of an amount of power from the planned total power to the target total power.
(7): In the above aspect (3), the margin securing unit may calculate the first margin by multiplying an absolute value of an amount of power from the planned total power to the baseline by a predetermined coefficient.
(8): In the above aspect (3), the margin securing unit may calculate the second margin by multiplying an absolute value of an amount of power from the planned total power to the target total power at the time of securing by a predetermined coefficient.
(9): According to another aspect of the present invention, there is provided a method for controlling an amount of power demand of power supplied from an external power source to a battery of a vehicle in response to a request for DR. The method includes: by a computer of a control device, calculating a baseline indicating a predicted value of an amount of power demand expected in a case where DR is not implemented, on the basis of performance data indicating a past amount of power demand; calculating a target total power at the time of securing, which indicates a maximum amount of power to be secured based on the baseline, on the basis of contracted power determined in accordance with a DR bidding result; calculating a planned total power, which indicates a predicted value of an amount of power demand expected in a case where DR is not implemented, on the basis of a charging plan for the vehicle; and securing a first resource, which is an amount of power from the planned total power to the baseline, and a second resource, which is an amount of power from the planned total power to the target total power at the time of securing.

According to the above aspects (1) to (9), it is possible to improve the accuracy of resource securing in the DR. In a case where an error occurs between the actual demand due to the charging response of the vehicle on the day of DR and the demand, resources in the opposite direction to the contracted direction may be required depending on the magnitude of the error and instructed power. By using the planned total power as a starting point and securing resources for both the baseline and the target total power, it becomes possible to allocate the amount of power even in such cases.

According to the above aspects (3) to (5), (7), and (8), by controlling margin securing in addition to resource securing control, it is possible to more reliably secure resources.

### BRIEF DESCRIPTION OF THE DRAWINGS

FIG. 1 is a diagram showing an example of a configuration of a demand response management system according to an embodiment.

FIG. 2 is a functional block diagram showing an example of a configuration of a terminal device according to the embodiment.

FIG. 3 is a flowchart showing an example of a flow of processing performed by a control device according to the embodiment.

FIG. 4A is a diagram showing a state where the amounts of power are allocated under a first condition according to the embodiment.

FIG. 4B is a diagram showing a state where the amounts of power are allocated under second and third conditions according to the embodiment.

FIG. 5A is a diagram showing a state where the amounts of power are allocated under a fourth condition according to the embodiment.

FIG. 5B is a diagram showing a state where the amounts of power are allocated under fifth and sixth conditions according to the embodiment.

FIG. 6A is a diagram showing a state where the amounts of power are allocated under Conditions 1 and 2 according to the related art.

FIG. 6B is a diagram illustrating the allocation of amounts of power under Condition 3 by comparing the related art with the embodiment.

### DETAILED DESCRIPTION OF THE INVENTION

Hereinafter, embodiments of a control device and a control method of the present invention will be described with reference to the drawings.

### <Overview>

The control device and the control method of the present embodiment use a planned total power calculated on the basis of a charging plan for each vehicle, which is more accurate in relation to actual demand than a baseline, as a reference, and secure resources in terms of the amount of power for both a target total power at the time of securing, which is a value that reflects contracted power relative to the baseline, and the baseline. This enables a response in accordance with the target total power, which is an actual supply and demand instruction, and improves the accuracy of resource securing in DR.

The baseline indicates the amount of power demand of a battery B of a vehicle M that is expected in a case where there was no DR request. For example, when batteries B of a plurality of vehicles M are subject to control for DR (hereinafter referred to as “DR control”), the baseline is the total value (predicted value) of the amounts of power demand of the plurality of batteries B that are expected in a case where there was no DR request. The baseline is calculated on the basis of performance data indicating the past amount of power demand. The baseline is calculated, for example, on the basis of the demand data for the four days with the highest average demand amount during the DR implementation time period out of the five days immediately preceding the DR implementation date (High 4 of 5). The baseline is calculated, for example, a predetermined time (for example, two hours) before the start of DR.

The target total power at the time of securing indicates the maximum amount of power to be secured based on the baseline. The target total power at the time of securing is calculated a predetermined time (for example, one hour) before the start of DR, on the basis of the contracted power of the supply and demand request determined in accordance with DR bidding results. The contracted power indicates the maximum secured power value from the baseline. Contracted power refers to power that has been traded in the supply and demand adjustment market. Specifically, the contracted power is the value of power confirmed by a general power transmission and distribution business on the basis of a bidding process to adjust the supply and demand balance, and is determined within the range of the amount of power that can be supplied. The amount of power that can be supplied is determined on the basis of a value representing the state of charge (SOC) of the battery B of the vehicle M, etc.

The planned total power indicates the amount of power demand of the battery B of the vehicle M that is expected in a case where DR is not implemented, taking into account the charging plan for the vehicle M. The planned total power is a predicted value obtained by adding up the amount of power (charging amount or discharging amount) used by a vehicle that will be charged or discharged during the DR implementation time period, on the basis of, for example, a vehicle use schedule of the vehicle M that is fitted to a charging/discharging device 5 and a value representing the state of charge (SOC) of the battery B of the vehicle M. The calculation method for the planned total power is different from that for the baseline, and is calculated taking into account the charge and discharge schedule on the day of DR. For this reason, it is expected that the planned total power will be a more accurate value (with a smaller error) than the baseline.

The target total power is calculated on the basis of the baseline and the instructed power included in the DR request transmitted from an electric utility device 3 before the start of DR. In the case of control to reduce power demand in response to a request from an electric utility or the like (hereinafter referred to as “downward DR”), the power value obtained by subtracting the instructed power from the baseline becomes the target total power. On the other hand, in the case of control to increase power demand in response to a request from an electric utility or the like (hereinafter referred to as “upward DR”), the power value obtained by adding the instructed power to the baseline becomes the target total power.

### (Comparison With Related Art)

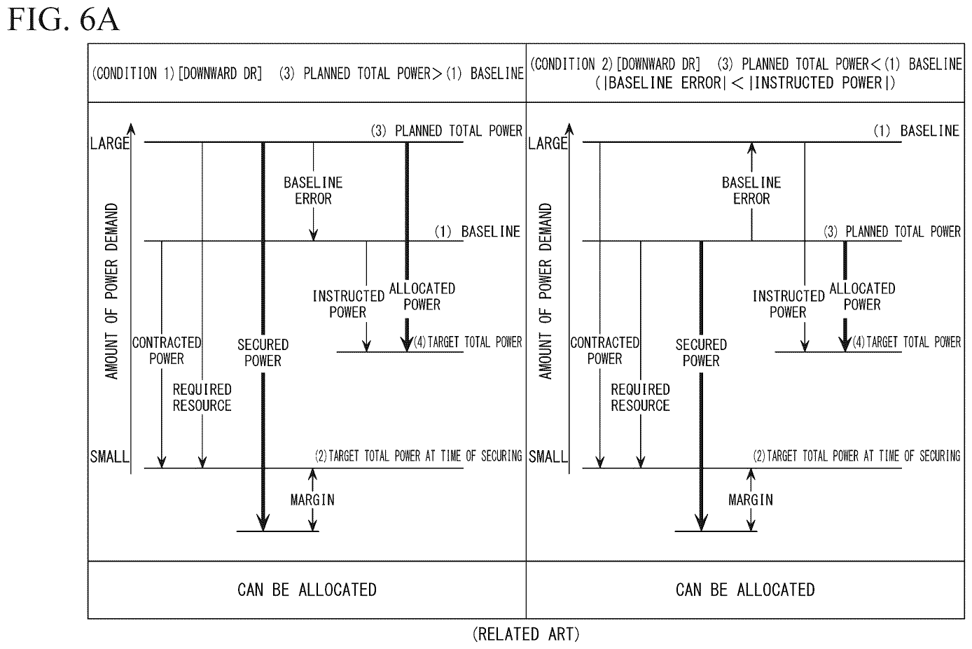

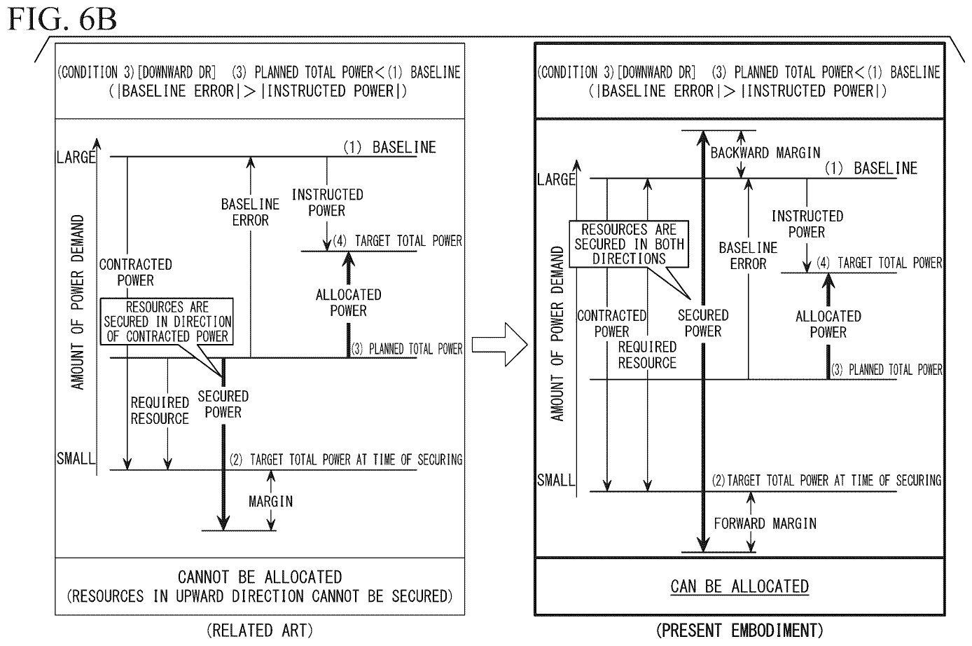

FIGS. 6A and 6B are diagrams showing a state where the amounts of power are allocated in the related art. Here, an example will be described in which control is performed according to a downward DR.

“Condition 1” in FIG. 6A shows a case where “(3) Planned total power” calculated on the basis of the charging plan for vehicle M is greater than “(1) Baseline” calculated on the basis of performance data indicating the past amount of power demand. Here, in the related art, resources (secured power, negative power amount) are secured by adding a “margin” to “(2) Target total power at time of securing” in the direction of the contracted power (that is, the direction of reducing the amount of power demand) based on “(3) Planned total power”. Under the condition, in a case where “(4) Target total power” is set in response to a request for a downward DR to reduce the amount of power demand from “(1) Baseline” by the amount of “Instructed power”, it is actually necessary to reduce the amount of power demand (allocated power) from “(3) Planned total power” to “(4) Target total power”. Since the downward power amount from “(3) Planned total power” to “(4) Target total power” is included in the range of resources secured as described above (secured power), it is possible to secure resources. “Condition 2” in FIG. 6A shows a case where “(3) Planned total power” is less than “(1) Baseline” and “Baseline error” is less than “Instructed power”. The “Baseline error” is the absolute value of the difference between “(1) Baseline” and “(3) Planned total power”. Here, in the related art, resources (secured power, negative power amount) are secured by adding a “margin” to “(2) Target total power at time of securing” in the direction of the contracted power (that is, the direction of reducing the amount of power demand) based on “(3) Planned total power”. Under the condition, in a case where “(4) Target total power” is set in response to a request for a downward DR to reduce the amount of power demand from “(1) Baseline” by the amount of “Instructed power”, it is actually necessary to reduce the amount of power demand (allocated power) from “(3) Planned total power” to “(4) Target total power”. Since the downward power amount from “(3) Planned total power” to “(4) Target total power” is included in the range of resources secured as described above (secured power), it is possible to secure resources. “Condition 3 of the related art” in FIG. 6B shows a case where “(3) Planned total power” is less than “(1) Baseline” and “Baseline error” is greater than “Instructed power”. Here, in the related art, resources (secured power, negative power amount) are secured by adding a “margin” to “(2) Target total power at time of securing” in the direction of the contracted power (that is, the direction of reducing the amount of power demand) based on “(3) Planned total power”. Under the condition, in a case where “(4) Target total power” is set in response to a request for a downward DR to reduce the amount of power demand from “(1) Baseline” by the amount of “Instructed power”, it is actually necessary to increase the amount of power demand (allocated power) from “(3) Planned total power” to “(4) Target total power”. The upward power amount from “(3) Planned total power” to “(4) Target total power” is not included in the range of resources secured as described above (secured power), which creates the problem that resources cannot be secured.

On the other hand, “Condition 3 of the present embodiment” in FIG. 6B differs from the related art in the method of securing resources. In the present embodiment, in addition to securing resources in the direction of the contracted power (that is, in the direction of reducing the amount of power demand) based on “(3) Planned total power”, resources are also secured in the direction of the baseline (that is, in the direction of increasing the amount of power demand) based on “(3) Planned total power”. In other words, resources are secured in both directions, that is, in a downward direction based on “(3) Planned total power”, resources obtained by adding “Forward margin” to “(2) Target total power at time of securing”, and in an upward direction based on “(3) Planned total power”, resources obtained by adding “Backward margin” to “(1) Baseline”. Under the condition, in a case where “(4) Target total power” is set in response to a request for a downward DR to reduce the amount of power demand from “(1) Baseline” by the amount of “Instructed power”, it is actually necessary to increase the amount of power demand (allocated power) from “(3) Planned total power” to “(4) Target total power”. Since the upward power amount from “(3) Planned total power” to “(4) Target total power” is included in the range of resources secured as described above (secured power), it is possible to secure resources.

### <Overall Configuration>

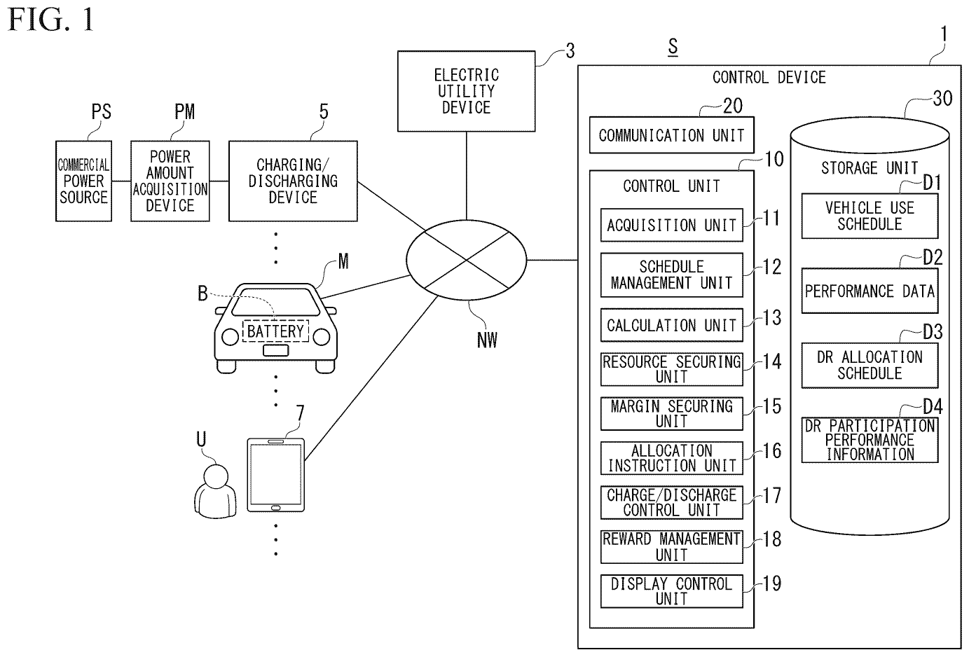

FIG. 1 is a diagram showing an example of a configuration of a demand response management system S (hereinafter referred to as “DR management system S”) according to an embodiment. The DR management system S performs DR control by utilizing V2G technology, which supplies power from a storage battery (hereinafter referred to as “battery”) installed in a vehicle to the power grid (power trading market), and controlling the charging and discharging of the battery. The DR management system S realizes a series of functions necessary for DR control, such as managing each user's DR participation plan, managing the resources of vehicles (batteries) that are subject to DR control, managing the execution of charging and discharging associated with DR control, and managing rewards for users who participate in DR.

A vehicle is incorporated into DR control, for example, by fitting a charging port of the vehicle to a charging plug of a charging/discharging device provided in a user's residence. When the upward DR control is started, the battery is charged (or measures are taken to prevent the battery from being discharged). On the other hand, when the downward DR control is started, the battery is discharged (or measures are taken to prevent the battery from being charged).

The DR management system S includes, for example, a control device 1, an electric utility device 3, one or more charging/discharging devices 5, one or more terminal devices 7, and one or more vehicles M. The devices, terminals, vehicles, and the like of the DR management system S are communicatively connected to each other via a communication network NW. The communication network NW is, for example, the Internet, a mobile communication network, a wide area network (WAN), a local area network (LAN), a cellular network, and the like.

The control device 1 performs overall control of the DR management system S. The control device 1 controls the charging and discharging of the battery B installed in the vehicle M connected to the charging/discharging device 5, for example, in response to a DR request (hereinafter also referred to as a “DR plan”) received from the electric utility device 3. Details of the control device 1 will be described later. The control device 1 is an example of a “control device that controls an amount of power demand of power supplied from an external power source to a battery of a vehicle in response to a request for DR”.

The electric utility device 3 is used by businesses that supply electricity, such as power transmission and distribution businesses and retail electric utilities. The electric utility device 3 creates a DR plan (for example, a daily DR plan) according to the power storage status, and notifies power consumers such as businesses and households of the DR plan. In the DR management system S, the electric utility device 3 transmits a DR plan to the control device 1 via the communication network NW, for example, daily.

The charging/discharging device 5 (also referred to as “charging/discharging equipment”) charges and discharges the battery B installed in the vehicle M. The charging/discharging device 5 is installed, for example, at the residence of a user U of the vehicle M or at a public charging station. The charging/discharging device 5 charges the battery B using system energy supplied from an external power source (a commercial power source PS, which is a general power distribution network, a system) or renewable energy generated by a power generation device provided in a residence or the like. The charging/discharging device 5 discharges the battery B by returning the power stored in the battery B to the commercial power source PS. A power amount acquisition device PM is provided between the charging/discharging device 5 and the commercial power source PS. The power amount acquisition device PM acquires the amount of power transmitted and received between the commercial power source PS and the battery B. The power amount acquisition device PM is, for example, a smart meter. The power amount acquisition device PM transmits the acquired data on the amount of power to the control device 1, the charging/discharging device 5, the terminal device 7, and the like.

The vehicle M may be, for example, a four-wheeled, two-wheeled, or three-wheeled vehicle. The drive source of the vehicle is, for example, an electric motor, or a combination of an electric motor and an internal combustion engine such as a diesel engine or a gasoline engine. The electric motor operates using discharged power from a battery B, which is a secondary battery or a fuel cell, or power generated by a generator connected to the internal combustion engine. The vehicle M is, for example, an electric vehicle, a hybrid vehicle, an electric motorcycle, or the like.

The vehicle M is used, for example, by a user U (also referred to as a “driver”). When the user U returns home, the user connects (fits) the charging plug of the charging/discharging device 5 provided in the residence to the charging port of the vehicle M, thereby enabling charging and discharging of the vehicle M. Alternatively, the user U goes to a charging station and connects (fits) the charging plug of the charging/discharging device 5 provide in the charging station to the charging port of the vehicle M, thereby enabling charging and discharging of the vehicle M.

The terminal device 7 is used by the user U, for example. The terminal device 7 is, for example, a smartphone, a tablet terminal, a general-purpose personal computer, or the like. The terminal device 7 may be connected to the vehicle M and function as an in-vehicle device. The terminal device 7 transmits the information input by the user U to the control device 1 and the like. The terminal device 7 outputs the information transmitted from the control device 1 and notifies the user U of the information. The terminal device 7 executes a pre-installed demand response application (hereinafter referred to as a “DR application”) to realize various functions for participating in DR control. These various functions may be realized using a general-purpose application program such as a web browser that runs on the terminal device 7. Details of the terminal device 7 will be described later.

### <Control Device>

Next, the configuration of the control device 1 will be described in detail. As shown in FIG. 1, the control device 1 includes, for example, a control unit 10, a communication unit 20, and a storage unit 30.

The control unit 10 controls the overall operation of the control device 1. The control unit 10 includes, for example, an acquisition unit 11, a schedule management unit 12, a calculation unit 13, a resource securing unit 14, a margin securing unit 15, an allocation instruction unit 16, a charge/discharge control unit 17, a reward management unit 18, and a display control unit 19. Each functional unit of the control unit 10 is realized by a hardware processor (computer) such as a central processing unit (CPU) executing a program (software). Some or all of these components may be realized by hardware such as a large scale integration (LSI), an application specific integrated circuit (ASIC), a field-programmable gate array (FPGA), a graphics processing unit (GPU), or a system on chip (SOC) or may be realized by cooperation of software and hardware. The control device 1 is not limited to a single device, and a plurality of devices may work together to realize each functional unit of the control unit 10.

The acquisition unit 11 acquires various types of information from external devices via the communication network NW. The acquisition unit 11 acquires various types of information stored in the storage unit 30. For example, the acquisition unit 11 acquires various types of input information related to DR control input by the user U of the vehicle M via the terminal device 7. The acquisition unit 11 acquires performance data of the amount of power transmitted from the power amount acquisition device PM, links the performance data to the user U (or the vehicle M), and registers it in performance data D2 stored in the storage unit 30.

The schedule management unit 12 manages various schedules related to DR control. For example, the schedule management unit 12 links the vehicle use schedule input by the user U via the terminal device 7 to the user U (or the vehicle M) and registers it in a vehicle use schedule D1 stored in the storage unit 30. The vehicle use schedule D1 includes, for example, information on vehicle use times (departure times and return times). The user U can set the vehicle use time for one week, for example, on the schedule management screen displayed on the terminal device 7.

The calculation unit 13 calculates various values used to secure resources in response to a DR request (DR response). The calculation unit 13 calculates, for example, a baseline, a target total power at the time of securing, a planned total power, a target total power (the amount of power up to the target total power determined in accordance with the planned total power and a DR request value), and the like. The calculation unit 13 is an example of a “calculation unit”.

The resource securing unit 14 secures resources (amount of power) required for DR control on the basis of the various values calculated by the calculation unit 13. The resource securing unit 14 secures a first resource, which is the amount of power from the planned total power to the baseline, and a second resource, which is the amount of power from the planned total power to the target total power at the time of securing. Under the condition of a request for a downward DR, the resource securing unit 14 secures the second resource in a case where the planned total power is greater than the baseline, and secures the first resource and the second resource in a case where the planned total power is less than the baseline. Under the condition of a request for an upward DR, the resource securing unit 14 secures the second resource in a case where the planned total power is less than the baseline, and secures the first resource and the second resource in a case where the planned total power is greater than the baseline. Details of the resource securing unit 14 will be described later. The resource securing unit 14 is an example of a “resource securing unit”.

The margin securing unit 15 calculates and secures a margin, which is an extra margin for the resources secured by the resource securing unit 14. The margin securing unit 15 secures at least one of a first margin, which is an extra margin of the amount of power in a first direction of the baseline from the planned total power, and a second margin, which is an extra margin of the amount of power in a second direction of the target total power at the time of securing from the planned total power. Under the condition of a request for a downward DR, the margin securing unit 15 calculates and secures a second margin in a case where the planned total power is greater than the baseline, and calculates and secures a first margin and a second margin in a case where the planned total power is less than the baseline. Under the condition of a request for an upward DR, the margin securing unit 15 calculates and secures a second margin in a case where the planned total power is less than the baseline, and calculates and secures a first margin and a second margin in a case where the planned total power is greater than the baseline. The margin securing unit 15 calculates a first margin (for example, a value that is 20% of the absolute value) by multiplying the absolute value of the amount of power of the baseline from the planned total power by a predetermined coefficient (for example, 0.2). The margin securing unit 15 calculates a second margin (for example, a value that is 20% of the absolute value) by multiplying the absolute value of the amount of power of the target total power at the time of securing from the planned total power by a predetermined coefficient (for example, 0.2). The margin securing unit 15 secures power as secured power by securing a margin in the downward direction in the case of an upward DR, and in the opposite direction (vertical direction) to the upward direction and the contracted direction in the case of a downward DR. The margin securing unit 15 is an example of a “margin securing unit”.

The allocation instruction unit 16 instructs the allocation of the amount of power from the planned total power to the target total power. In the present embodiment, allocating the amount of power means specifying a target (the battery B of the vehicle M) that bears the amount of power (the amount of power demand) that needs to be adjusted in response to a DR request. The allocation instruction unit 16 links the result of the allocation to the user U (or the vehicle M) and registers it in a DR allocation schedule D3 stored in the storage unit 30. The allocation instruction unit 16 is an example of an “allocation instruction unit”.

The charge/discharge control unit 17 controls the charging and discharging of the battery B of each vehicle M on the basis of the DR allocation schedule D3, thereby adjusting the exchange of power between the battery B and the commercial power source PS. The charge/discharge control unit 17 controls the charging and discharging of the battery B of each vehicle M by transmitting a charge/discharge control request based on the DR request to the charging/discharging device 5 (for example, the charging/discharging device 5 provided in the residence of the user U) associated with user U who is registered as a participant in the DR allocation schedule D3.

The reward management unit 18 manages rewards for the user U according to the performance of participation in the exchange of power between the battery B and the commercial power source PS. The reward management unit 18 links the reward for the user U to the user U (or the vehicle M) and registers it in DR participation performance information D4 stored in the storage unit 30.

The display control unit 19 controls the display of the display unit (display device) of the terminal device 7. The display control unit 19 generates notification information (information indicating display content) for the user on the basis of the processing results of the various functions of the control unit 10 and transmits the notification information to the terminal device 7. Accordingly, various types of information is displayed on the display unit of the terminal device 7.

The communication unit 20 communicates with external devices such as the electric utility device 3, the charging/discharging device 5, the terminal device 7, the vehicle M, and the power amount acquisition device PM via the communication network NW. The communication unit 20 is, for example, a network card for connecting to the communication network NW.

The storage unit 30 stores various types of information necessary for DR control. The storage unit 30 is realized by, for example, an HDD, a flash memory, an electrically erasable programmable read only memory (EEPROM), a read only memory (ROM), or a random access memory (RAM). The storage unit 30 stores, for example, a vehicle use schedule D1, performance data D2, a DR allocation schedule D3, and DR participation performance information D4. The storage unit 30 may be realized by another storage device, such as an external storage server device, connected via the communication network NW.

### <Terminal Device>

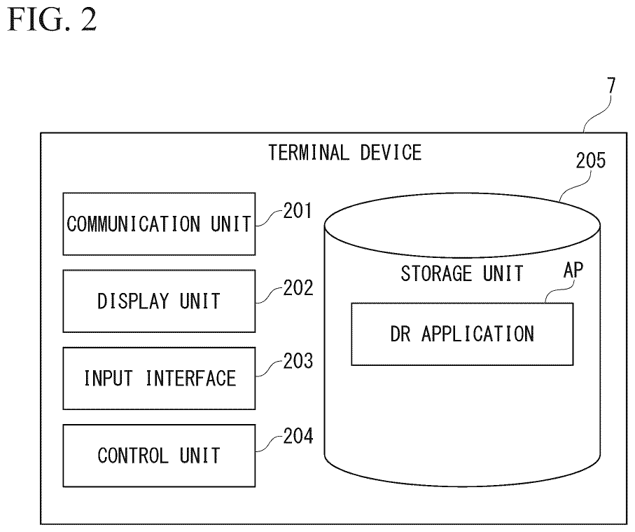

FIG. 2 is a functional block diagram showing an example of a configuration of the terminal device 7 according to the embodiment. The terminal device 7 includes, for example, a communication unit 201, a display unit 202, an input interface 203, a control unit 204, and a storage unit 205.

The communication unit 201 communicates with external devices such as the control device 1, the electric utility device 3, the charging/discharging device 5, the vehicle M, and the power amount acquisition device PM via the communication network NW. The communication unit 201 is, for example, a network card for connecting to the communication network NW.

The display unit 202 displays various types of information related to DR control. The display unit 202 displays images generated by the control unit 204, a graphical user interface (GUI) for receiving various input operations from the user U, and the like. For example, the display unit 202 is a liquid crystal display (LCD) or an organic electro luminescence (EL) display.

The input interface 203 receives various input operations from the user U, converts the received input operations into electrical signals, and outputs the electrical signals to the control unit 204. For example, the input interface 203 includes a touch panel, a keyboard, a mouse, and the like.

The control unit 204 controls the overall operation of the terminal device 7. For example, the control unit 204 realizes various functions for participating in DR control by causing a hardware processor (computer) such as a CPU to execute a DR application AP stored in the storage unit 205. The control unit 204 realizes, for example, a schedule management function, a reward management function, and the like.

The storage unit 205 stores various types of information related to DR control. The storage unit 205 is realized by, for example, an HDD, a flash memory, an EEPROM, a ROM, or a RAM. The storage unit 205 stores, for example, a DR application AP. The DR application is an example of an “application program”.

### <Processing Flow>

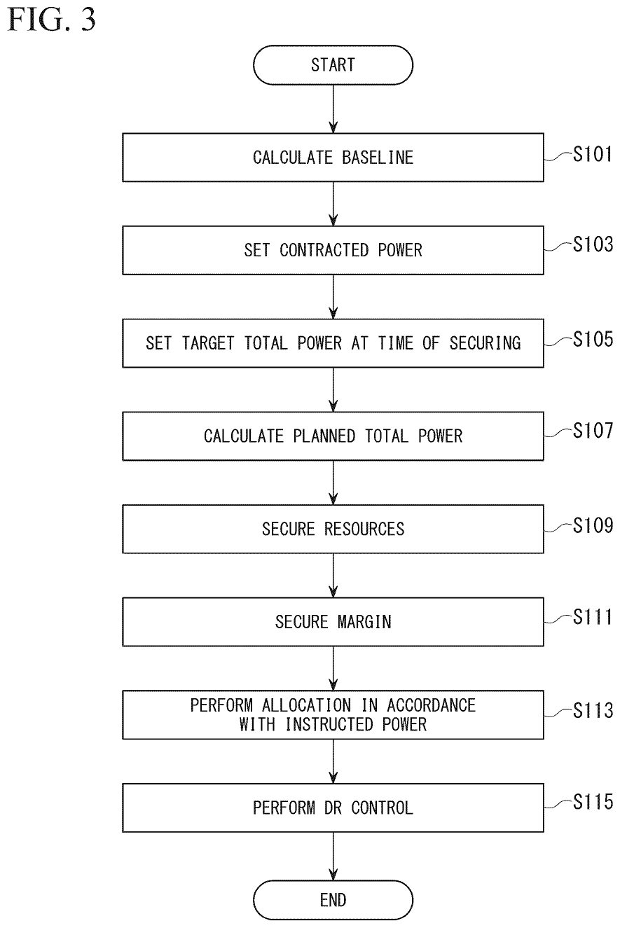

Next, the flow of processing performed by the control device 1 will be described. FIG. 3 is a flowchart showing an example of the flow of processing performed by the control device 1 according to the embodiment. The processing shown in FIG. 3 is started, for example, a predetermined time before the start of DR set on the basis of the DR plan.

First, the calculation unit 13 calculates a baseline on the basis of the performance data D2 indicating the past amount of power demand stored in the storage unit 30 (step S101). The calculation unit 13 calculates the baseline using, for example, the High 4 of 5 method.

Next, the calculation unit 13 sets the contracted power on the basis of the results of the bidding conducted in response to the DR request (step S103). Next, the calculation unit 13 calculates and sets a target total power at the time of securing based on the baseline and the set contracted power (step S105).

Next, the calculation unit 13 calculates a planned total power in consideration of the charging plan for the vehicle M fitted to the charging/discharging device 5 (step S107). For example, the calculation unit 13 calculates a planned total power by adding up the amount of power (charging amount) used by the vehicle that will be charged or discharged during the DR implementation time period on the basis of the vehicle use schedule D1 of the vehicle M that is fitted to the charging/discharging device 5 and the SOC of the battery B of the vehicle M.

Next, the resource securing unit 14 secures a first resource, which is the amount of power from the planned total power to the baseline, and a second resource, which is the amount of power from the planned total power to the target total power at the time of securing (step S109).

Next, the margin securing unit 15 calculates and secures a margin for the resource secured by the resource securing unit 14 (step S111). The margin securing unit 15 secures margins in both directions: a first margin in a first direction from the planned total power to the baseline, and a second margin in a second direction from the planned total power to the target total power at the time of securing.

Next, the allocation instruction unit 16 instructs the allocation of the amount of power from the planned total power to the target total power in accordance with the instructed power included in the DR request (step S113). The allocation instruction unit 16 links the result of the allocation to the user U (or the vehicle M) and registers it in the DR allocation schedule D3 stored in the storage unit 30.

### (First Condition) Downward DR, Planned Total Power>Baseline

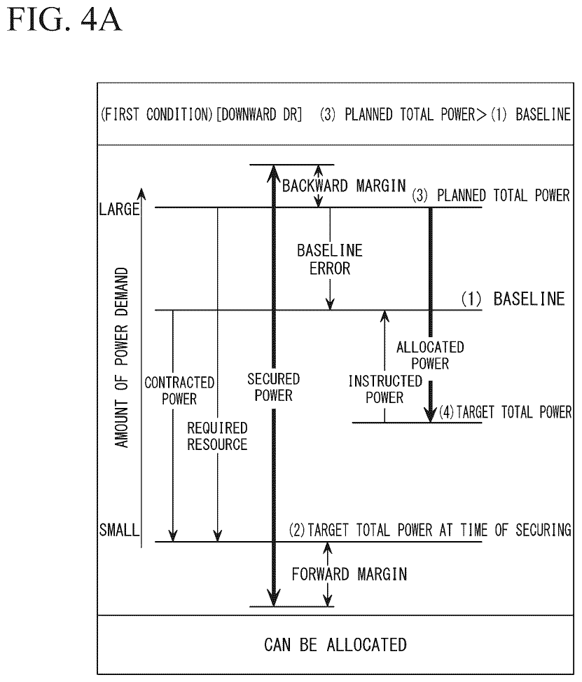

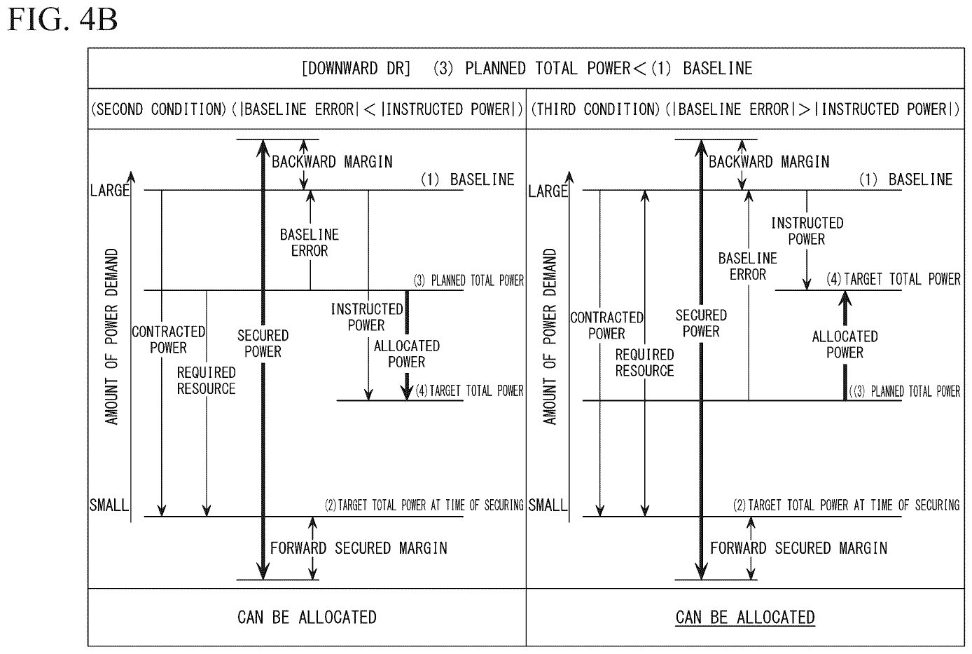

FIG. 4A is a diagram showing a state where the amounts of power are allocated under a first condition according to the embodiment. This first condition indicates a case where “(3) Planned total power” is greater than “(1) Baseline”. Here, a first resource, which is the amount of power from “(3) Planned total power” to “(1) Baseline”, and a second resource, which is the amount of power from “(3) Planned total power” to “(2) Target total power at time of securing”, are secured. The first resource and the second resource are both resources in the same direction (downward direction) based on “(3) Planned total power”. For this reason, as a result, the first resource is included in the second resource. A forward margin in the downward direction from “(3) Planned total power” to “(2) Target total power at time of securing” is secured. Furthermore, a backward margin in the upward direction based on “(3) Planned total power” is secured. Under the condition, in a case where “(4) Target total power” is set in response to a request for a downward DR to reduce the amount of power demand from “(1) Baseline” by the amount of “Instructed power”, it is actually necessary to reduce the amount of power demand (allocated power) from “(3) Planned total power” to “(4) Target total power”. Since the downward power amount from “(3) Planned total power” to “(4) Target total power” is included in the range of resources secured as described above (secured power), it is possible to secure resources.

### (Second Condition) Downward DR, Planned Total Power<Baseline, |Baseline Error|<|Instructed Power|

FIG. 4B is a diagram showing a state where the amounts of power are allocated under second and third conditions according to the present embodiment. This second condition indicates a case where “(3) Planned total power” is less than “(1) Baseline” and “|Baseline error|” is less than “|Instructed power|”. Here, a first resource, which is the amount of power from “(3) Planned total power” to “(1) Baseline”, and a second resource, which is the amount of power from “(3) Planned total power” to “(2) Target total power at time of securing”, are secured. A forward margin in the downward direction from “(3) Planned total power” to “(2) Target total power at time of securing” and a backward margin in the upward direction from “(3) Planned total power” to “(1) Baseline” are secured. Under the condition, in a case where “(4) Target total power” is set in response to a request for a downward DR to reduce the amount of power demand from “(1) Baseline” by the amount of “Instructed power”, it is actually necessary to reduce the amount of power demand (allocated power) from “(3) Planned total power” to “(4) Target total power”. Since the downward power amount from “(3) Planned total power” to “(4) Target total power” is included in the range of resources secured as described above (secured power), it is possible to secure resources.

### (Third Condition) Downward DR, Planned Total Power<Baseline, |Baseline Error|>|Instructed Power|

As shown in FIG. 4B, the third condition indicates a case where “(3) Planned total power” is less than “(1) Baseline” and “|Baseline error|” is greater than “|Instructed power|”. Here, a first resource, which is the amount of power from “(3) Planned total power” to “(1) Baseline”, and a second resource, which is the amount of power from “(3) Planned total power” to “(2) Target total power at time of securing”, are secured. A forward margin in the downward direction from “(3) Planned total power” to “(2) Target total power at time of securing” and a backward margin in the upward direction from “(3) Planned total power” to “(1) Baseline” are secured. Under the condition, in a case where “(4) Target total power” is set in response to a request for a downward DR to reduce the amount of power demand from “(1) Baseline” by the amount of “Instructed power”, it is actually necessary to increase the amount of power demand (allocated power) from “(3) Planned total power” to “(4) Target total power”. Since the upward power amount from “(3) Planned total power” to “(4) Target total power” is included in the range of resources secured as described above (secured power), it is possible to secure resources.

### (Fourth Condition) Upward DR, Planned Total Power<Baseline

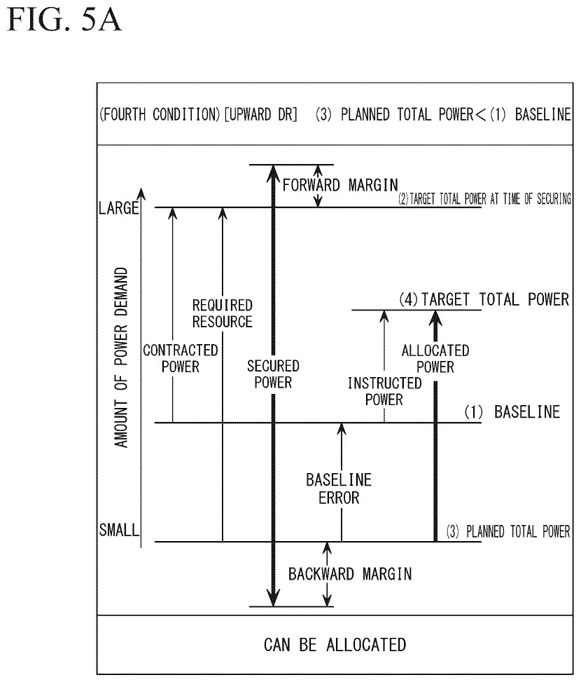

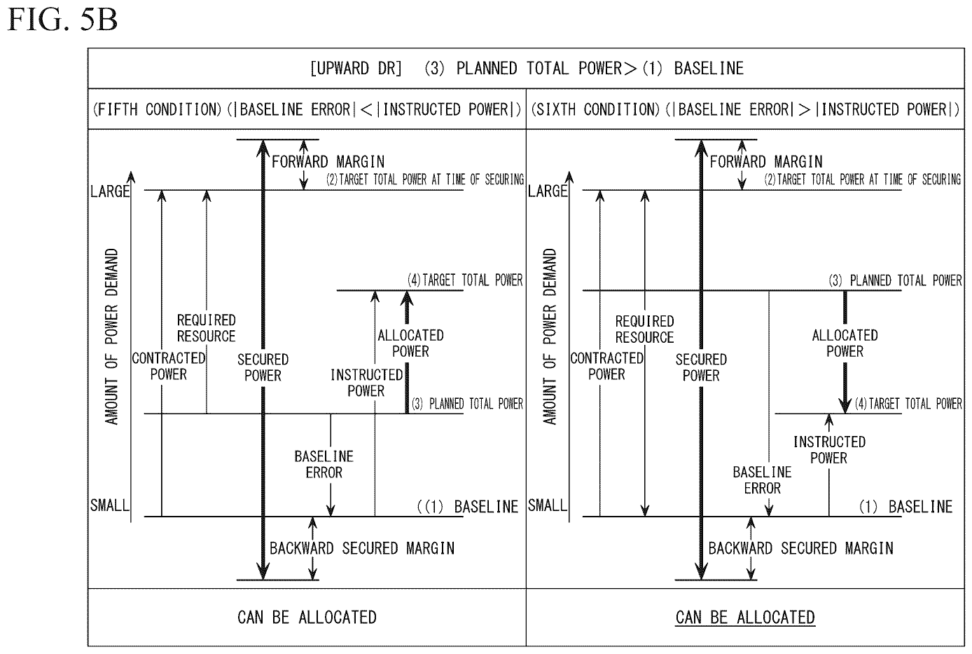

FIG. 5A is a diagram showing a state where the amounts of power are allocated under a fourth condition according to the present embodiment. This fourth condition indicates a case where “(3) Planned total power” is less than “(1) Baseline”. Here, a first resource, which is the amount of power from “(3) Planned total power” to “(1) Baseline”, and a second resource, which is the amount of power from “(3) Planned total power” to “(2) Target total power at time of securing”, are secured. The first resource and the second resource are both resources in the same direction (upward direction) based on “(3) Planned total power”. For this reason, as a result, the first resource is included in the second resource. A forward margin in the upward direction from “(3) Planned total power” to “(2) Target total power at time of securing” is secured. Furthermore, a backward margin in the downward direction based on “(3) Planned total power” is secured. Under the condition, in a case where “(4) Target total power” is set in response to a request for an upward DR to increase demand by the amount of “Instructed power” from “(1) Baseline”, it is actually necessary to increase the amount of power demand (allocated power) from “(3) Planned total power” to “(4) Target total power”. Since the upward power amount from “(3) Planned total power” to “(4) Target total power” is included in the range of resources secured as described above (secured power), it is possible to secure resources.

### (Fifth Condition) Upward DR, Planned Total Power>Baseline, |Baseline Error|<|Instructed Power|

FIG. 5B is a diagram showing a state where the amounts of power are allocated under fifth and sixth conditions according to the present embodiment. This fifth condition indicates a case where “(3) Planned total power” is greater than “(1) Baseline” and |Baseline error|is less than |Instructed power|. Here, a first resource, which is the amount of power from “(3) Planned total power” to “(1) Baseline”, and a second resource, which is the amount of power from “(3) Planned total power” to “(2) Target total power at time of securing”, are secured. A forward margin in the upward direction from “(3) Planned total power” to “(2) Target total power at time of securing” and a backward margin in the downward direction from “(3) Planned total power” to “(1) Baseline” are secured. Under the condition, in a case where “(4) Target total power” is set in response to a request for an upward DR to increase the amount of power demand from “(1) Baseline” by the amount of “Instructed power”, it is actually necessary to increase the amount of power demand (allocated power) from “(3) Planned total power” to “(4) Target total power”. Since the upward power amount from “(3) Planned total power” to “(4) Target total power” is included in the range of resources secured as described above (secured power), it is possible to secure resources.

### (Sixth Condition) Upward DR, Planned Total Power >Baseline, |Baseline Error|>|Instructed Power|

As shown in FIG. 5B, the sixth condition indicates a case where “(3) Planned total power” is greater than “(1) Baseline” and “|Baseline error|” is greater than “|Instructed power|”. Here, a first resource, which is the amount of power from “(3) Planned total power” to “(1) Baseline”, and a second resource, which is the amount of power from “(3) Planned total power” to “(2) Target total power at time of securing”, are secured. A forward margin in the upward direction from “(3) Planned total power” to “(2) Target total power at time of securing” and a backward margin in the downward direction from “(3) Planned total power” to “(1) Baseline” are secured. Under the condition, in a case where “(4) Target total power” is set in response to a request for an upward DR to increase the amount of power demand from “(1) Baseline” by the amount of “Instructed power”, it is actually necessary to reduce the amount of power demand (allocated power) from “(3) Planned total power” to “(4) Target total power”. Since the downward power amount from “(3) Planned total power” to “(4) Target total power” is included in the range of resources secured as described above (secured power), it is possible to secure resources.

Referring back to FIG. 3, next, the charge/discharge control unit 17 performs DR control by controlling the charging and discharging of the battery B of each vehicle M on the basis of the DR allocation schedule D3 (step S115). The charge/discharge control unit 17 controls the charging and discharging of the battery B of each vehicle M by transmitting a charge/discharge control request based on the DR request to the charging/discharging device 5 (for example, the charging/discharging device 5 provided in the residence of the user U) associated with user U who is registered as a participant in the DR allocation schedule D3. As described above, the processing in the flowchart ends.

According to the present embodiment described above, it is possible to improve the accuracy of resource securing in the DR. In a case where an error occurs between the actual demand due to the charging response of the vehicle on the day of DR and the demand, resources in the opposite direction to the contracted direction may be required depending on the magnitude of the error and instructed power. By using the planned total power as a starting point and securing resources for both the baseline and the target total power, it becomes possible to allocate the amount of power even in such cases. Robustness is improved under various conditions related to the magnitude relationship between the planned total power and the baseline, the magnitude relationship between the baseline error and the instructed power, etc., and it is possible to avoid situations where resources cannot be secured in response to a DR request. By controlling margin securing in addition to resource securing control, it is possible to more reliably secure resources.

The above describes the form for carrying out the present invention using an embodiment, but the present invention is not limited to such an embodiment, and various modifications and substitutions can be made within the scope that does not deviate from the gist of the present invention.

What is claimed is:

1. A control device that controls an amount of power demand of power supplied from an external power source to a battery of a vehicle in response to a request for demand response (DR), the control device comprising:
a calculation unit configured to
calculate a baseline indicating a predicted value of an amount of power demand expected in a case where DR is not implemented, on the basis of performance data indicating a past amount of power demand,
calculate a target total power at the time of securing, which indicates a maximum amount of power to be secured based on the baseline, on the basis of contracted power determined in accordance with a DR bidding result, and
calculate a planned total power, which indicates a predicted value of an amount of power demand expected in a case where DR is not implemented, on the basis of a charging plan for the vehicle; and
a resource securing unit configured to secure a first resource, which is an amount of power from the planned total power to the baseline, and a second resource, which is an amount of power from the planned total power to the target total power at the time of securing.

2. The control device according to claim 1, wherein the resource securing unit is configured to,
under a condition that the request for DR is a request to reduce the amount of power demand,
secure the second resource in a case where the planned total power is greater than the baseline, and
secure the first resource and the second resource in a case where the planned total power is less than the baseline, and
under a condition that the request for DR is a request to increase the amount of power demand,
secure the second resource in a case where the planned total power is less than the baseline, and
secure the first resource and the second resource in a case where the planned total power is greater than the baseline.

3. The control device according to claim 1, further comprising:
a margin securing unit configured to secure at least one of a first margin, which is an extra margin of an amount of power in a first direction of the baseline from the planned total power, and a second margin, which is an extra margin of an amount of power in a second direction of the target total power at the time of securing from the planned total power.

4. The control device according to claim 3, wherein the margin securing unit secures at least the second margin.

5. The control device according to claim 3, wherein the margin securing unit is configured to,
under a condition that the request for DR is a request to reduce the amount of power demand,
calculate and secure the second margin in a case where the planned total power is greater than the baseline, and
calculate and secure the first margin and the second margin in a case where the planned total power is less than the baseline, and
under a condition that the request for DR is a request to increase the amount of power demand,
calculate and secure the second margin in a case where the planned total power is less than the baseline, and
calculate and secure the first margin and the second margin in a case where the planned total power is greater than the baseline.

6. The control device according to claim 1, wherein
the calculation unit calculates an amount of power up to a target total power determined in accordance with the planned total power and a DR request value, and
the control device further comprises an allocation instruction unit configured to instruct an allocation of an amount of power from the planned total power to the target total power.

7. The control device according to claim 3, wherein the margin securing unit calculates the first margin by multiplying an absolute value of an amount of power from the planned total power to the baseline by a predetermined coefficient.

8. The control device according to claim 3, wherein the margin securing unit calculates the second margin by multiplying an absolute value of an amount of power from the planned total power to the target total power at the time of securing by a predetermined coefficient.

9. A method for controlling an amount of power demand of power supplied from an external power source to a battery of a vehicle in response to a request for demand response (DR), the method comprising:
by a computer of a control device,
calculating a baseline indicating a predicted value of an amount of power demand expected in a case where DR is not implemented, on the basis of performance data indicating a past amount of power demand;
calculating a target total power at the time of securing, which indicates a maximum amount of power to be secured based on the baseline, on the basis of contracted power determined in accordance with a DR bidding result;
calculating a planned total power, which indicates a predicted value of an amount of power demand expected in a case where DR is not implemented, on the basis of a charging plan for the vehicle; and
securing a first resource, which is an amount of power from the planned total power to the baseline, and a second resource, which is an amount of power from the planned total power to the target total power at the time of securing.
